(19) United States
(12) Patent Application Publication
(10) Pub. No.: US 2025/0318458 A1
(43) Pub. Date: Oct. 16, 2025

(54) COLLABORATIVE OPERATION METHOD FOR MULTIPLE MOWING ROBOTS, DEVICE AND PRODUCT

(71) Applicant: Jiangsu Artum Intelligent Technology Co., Ltd., Taicang City (CN)

(72) Inventors: Zhihui AN, Taicang City (CN); Meng DU, Taicang City (CN); Jun HUO, Taicang City (CN); Yi GUO, Taicang City (CN)

(73) Assignee: Jiangsu Artum Intelligent Technology Co., Ltd., Taicang City (CN)

(21) Appl. No.: 18/980,897

(22) Filed: Dec. 13, 2024

(30) Foreign Application Priority Data
Apr. 15, 2024 (CN) 202410449093.X

(51) Int. Cl. A01D 34/00; A01D 101/00

(52) U.S. Cl. CPC A01D 34/008; A01D 2101/00

(57) ABSTRACT

Provided are a collaborative operation method for multiple mowing robots, a device and a product, which relate to the field of collaborative operation of robots. The collaborative operation method for multiple mowing robots includes: acquiring state data of a mowing robot, environment and operation region data, and task execution data; establishing, according to the environment and operation region data, the state data of the mowing robot, state data of an unmanned aerial vehicle (UAV), starting point information of the mowing robot, and starting point information of the UAV, a complete map information with a traveling-salesman path method; performing multi-region segmentation according to the complete map information; determining costs of different tasks according to segmented regions, the state data of the mowing robot and the task execution data, and determining an optimal cost solution with a Hungarian algorithm.

### CROSS REFERENCE TO RELATED APPLICATION

This patent application claims the benefit and priority of Chinese Patent Application No. 202410449093.X, filed with the China National Intellectual Property Administration on Apr. 15, 2024, the disclosure of which is incorporated by reference herein in its entirety as part of the present application.

### TECHNICAL FIELD

The present disclosure relates to the field of collaborative operation of robots, and in particular to a collaborative operation method for multiple mowing robots, a device and a product.

### BACKGROUND

With the development of automatic and intelligent technologies, mowing robots are applied to agriculture and garden maintenance more widely. However, most existing mowing robots operate independently, and cannot meet ever-changing terrains and vegetation growing states effectively, which causes a low energy utilization rate, a high maintenance cost, and limited operation efficiency.

Hence, it is urgent to provide a method or system through which multiple mowing robots of different types operate collaboratively, thereby realizing efficient task assignment, and improving mowing efficiency and energy utilization efficiency of the robots.

### SUMMARY

An objective of the present disclosure is to provide a collaborative operation method for multiple mowing robots, a device and a product. The present disclosure can improve mowing efficiency and energy utilization efficiency of the robots.

To achieve the above objective, the present disclosure provides the following technical solutions:

The present disclosure provides a collaborative operation method for multiple mowing robots, including:
acquiring state data of a mowing robot, environment and operation region data, and task execution data, where the state data includes: an electric capacity or an oil capacity, a blade wearing state, a usage duration, a present position and a present speed; the environment and operation region data includes: positions and boundaries of workplaces, a type, a density and a growing state of a lawn, terrain information, and a weather condition; and the task execution data includes: task completion time, an energy consumption record and a mowing quality feedback;
establishing, according to the environment and operation region data, the state data of the mowing robot, state data of an unmanned aerial vehicle (UAV), starting point information of the mowing robot, and starting point information of the UAV, a complete map information of the workplaces with a traveling-salesman path method, where the complete map information of the workplaces includes: information of an obstacle; and the complete map information of the workplaces is used to determine an assignment result for the UAV and the mowing robot;
performing multi-region segmentation according to the complete map information of the workplaces;
determining costs of different tasks according to segmented regions, the state data of the mowing robot and the task execution data, and determining an optimal cost solution with a Hungarian algorithm; and
performing, in response to an unmanned mode, a collaborative operation according to the optimal cost solution; and performing, in response to a manned mode, a corresponding collaborative operation according to a comparison result between the optimal cost solution and a historical assignment result.

Optionally, the establishing, according to the environment and operation region data, the state data of the mowing robot, state data of a UAV, starting point information of the mowing robot, and starting point information of the UAV, a complete map information of the workplaces with a traveling-salesman path method specifically includes:
establishing a minimum optimization problem by min αΣ_{i∈C} (tᵢ-Tᵢ)⁺+z, where, α represents a penalty coefficient when latest arrival time is missed, tᵢ represents time when the UAV or the mowing robot reaches a node i, Tᵢ represents a latest deadline for completing a task of the node i, z represents a total duration for completing a whole task, and C represents a set of the workplaces; and
a constraint is as follows:

$${\sum }_{k ∈ K} {\sum }_{i ∈ C} {y}_{0 , i}^{k} = \vert K \vert \\ {\sum }_{i ∈ N , i \neq j} {y}_{i , j}^{k} = {\sum }_{s ∈ N , s \neq j} {y}_{j , s}^{k} ∀ j ∈ N , ∀ k ∈ K \\ {\sum }_{u ∈ U} {\sum }_{i ∈ N , j \neq i} {y}_{i , j}^{u} \leq 1 ∀ j ∈ C \\ {\sum }_{u ∈ U} {\sum }_{j ∈ N , i \neq j} {y}_{i , j}^{u} \leq 1 ∀ i ∈ C \\ {x}_{i}^{u} + {x}_{j}^{u} - {y}_{i , j}^{u} = 0 , ∀ i , j ∈ C , j \neq i \\ z \geq {t}_{i} ∀ i ∈ C \\ {\sum }_{k ∈ K} {x}_{i}^{k} + {\sum }_{u ∈ U} {x}_{i}^{u} = 1 , ∀ i ∈ C \\ {\sum }_{k ∈ K} {y}_{i , j}^{k} + {\sum }_{u ∈ U} {y}_{i , j}^{u} \leq 1 , ∀ i , j ∈ C , j \neq i \\ {l}_{i} + {d}_{i , j} - ( 1 - {\sum }_{k ∈ K {y}_{i , j}^{k}} ) M \leq {t}_{j} , ∀ i ∈ N , ∀ j ∈ C , j \neq i \\ {t}_{i} + {\hat{d}}_{i , j} - ( 2 - {\sum }_{u ∈ U} {y}_{i , j}^{u} - {\sum }_{u ∈ U} {x}_{j}^{u} ) M \leq {t}_{j} ∀ i , j ∈ C , j \neq i \\ {t}_{i} + {t}_{serve}^{i} \leq {l}_{i} ∀ i ∈ C \\ {t}_{i} + {\hat{d}}_{j , i} - ( 2 - {\sum }_{u ∈ U} {y}_{j , i}^{u} - {\sum }_{u ∈ U} {x}_{j}^{u} ) M \leq {l}_{j} ∀ i , j ∈ C , j \neq i \\ {\sum }_{k ∈ K} {x}_{i}^{k} * M \geq {q}_{i} ∀ i ∈ C \\ {q}_{i} + {\sum }_{u ∈ U} {\sum }_{s ∈ C , s \neq i} ( {y}_{s , i}^{u} - {y}_{i , s}^{u} ) - ( 1 - {\sum }_{k ∈ K} {y}_{i , i}^{k} ) M \leq {q}_{j} ∀ i ∈ C , \\ ∀ j ∈ C , j \neq i \\ {q}_{i} + {\sum }_{u ∈ U} {\sum }_{s ∈ C , s \neq i} ( {y}_{s , i}^{u} - {y}_{i , s}^{u} ) + ( 1 - {\sum }_{k ∈ K} {y}_{i , i}^{k} ) M \geq {q}_{j} ∀ i ∈ C , \\ ∀ j ∈ C , j \neq i \\ {\sum }_{s ∈ C , s \neq i} ( {\hat{d}}_{s , i} * {y}_{s , i}^{u} ) + {\sum }_{j ∈ C , j \neq i} ( {\hat{d}}_{i , j} * {y}_{i , j}^{u} ) \leq L ∀ i ∈ C , ∀ u ∈ U$$

where,

$${y}_{0 , i}^{k}$$

represents a Boolean value, which indicates whether a mowing robot k accesses the node i from a node 0, N and K each represent a set of mowing robots,

$${y}_{i , j}^{k}$$

represents a Boolean value, which indicates whether the mowing robot k accesses a node j from the node i,

$${y}_{j , s}^{k}$$

represents a Boolean value, which indicates whether the mowing robot k accesses a node s from the node j, U represents a set of UAVs,

$${y}_{i , j}^{u}$$

represents a Boolean value, winch indicates whether a UAV u accesses the node j from the node i,

$${x}_{i}^{u}$$

represents a Boolean value, which indicates whether the node i is accessed by the UAV u,

$${x}_{j}^{u}$$

represents a Boolean value, which indicates whether the node j is accessed by the UAV u,

$${x}_{i}^{k}$$

represents a Boolean value, which indicates whether the node i is accessed by the mowing robot k, lᵢ represents time when the UAV or the mowing robot leaves away the node i, d_{i,j} represents movement time of the mowing robot from the node i to the node j, M represents a randomly selected positive constant, \hat{d}_{i,j} represents movement time of the UAV from the node i to the node j,

$${t}_{serve}^{i}$$

represents time required to complete the task of the node i,

$${y}_{j , i}^{u}$$

represents a Boolean value, which indicates whether the UAV u accesses the node i from the node j, qᵢ represents a number of UAVs reaching the node i,

$${y}_{s , i}^{u}$$

represents a Boolean value, which indicates whether the UAV u accesses the node i from the node s,

$${y}_{i , s}^{u}$$

represents a Boolean value, which indicates whether the UAV u accesses the node s from the node i,

$${y}_{i , i}^{k}$$

represents a Boolean value, which indicates whether the mowing robot k accesses the node i from the node i, qⱼ represents a number of UAVs reaching the node j, L represents a maximum flying distance of the UAV, and C represents a number of the workplaces.

Optionally, before the determining costs of different tasks according to segmented regions, the state data of the mowing robot and the task execution data, and determining an optimal cost solution with a Hungarian algorithm, the collaborative operation method for multiple mowing robots further includes:
determining, according to the state data of the mowing robot and the task execution data, whether a present mowing robot can complete a corresponding task.

Optionally, the costs each are calculated by

$$cost ( {x}_{k} \cdot {m}_{k} ) = \{ \begin{matrix}∞ & no \cdot match \\ ϑ * energy + β * depreciation + γ * \frac{depreciation}{lifeexpectancy} & potential \cdot match\end{matrix} ,$$

where, xₖ represents a mowing robot k, mₖ represents a matched task of the mowing robot k, ∂, β and γ each are a weight coefficient, no match is an indication of no match, potential match is an indication of a potential match, energy represents the energy consumption record, depreciation represents a depreciation cost of the mowing robot, and lifeexpectancy represents a designed service life.

The present disclosure provides a computer device, including: a memory, a processor and a computer program stored in the memory and executable on the processor, where the processor executes the computer program to implement the collaborative operation method for multiple mowing robots.

Optionally, the memory is a computer-readable storage medium.

The present disclosure provides a computer program product, including a computer program, where the computer program is executed by a processor to implement the collaborative operation method for multiple mowing robots.

According to specific embodiments provided in the present disclosure, the present disclosure has the following technical effects:

According to the collaborative operation method for multiple mowing robots, the device and the product provided by the present disclosure, with state data of the mowing robots, monitoring on a vegetation growing state, as well as kinematical and dynamic constraints, efficient task assignment for multiple sets of mowing robots and multiple types of mowing robots is realized. By intelligently assigning tasks to different mowing robots, and considering an energy state, a mechanical state and a special function, the present disclosure can maximize a capability of each robot, thereby improving overall mowing efficiency. The improvement to the efficiency means that less time and energy are consumed on a same area in lawn maintenance. Through real-time monitoring and intelligent management on an electric capacity, an oil capacity and other parameters of the mowing robot, the present disclosure can make the robot operate efficiently, and minimize an energy waste. This not only reduces an operation cost, but also facilitates promotion of an operation mechanism in environmental protection. By intelligently assigning the tasks, the present disclosure prevents the robots from being used excessively or operating on an unsuitable terrain, and can effectively reduce mechanical wear. With the reduced wear, the present disclosure directly prolongs a service life of the robot, and reduces maintenance frequency and cost. With continuous operation and learning of the system, the present disclosure can continuously optimize a task assignment mechanism through a reinforcement learning algorithm to make response to an environmental change and a state change of the robot. This means that the operation efficiency and the energy utilization efficiency of the system are improved constantly over time to realize self-perfection. The intelligent system can accurately adjust a mowing strategy and a mowing intensity according to a growing state and a terrain feature of the lawn, thereby improving maintenance quality of the whole lawn, and ensuring uniform mowing and healthy growth of the lawn.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 schematically illustrates a flowchart of a collaborative operation method for multiple mowing robots according to Embodiment 1 of the present disclosure;

FIG. 2 schematically illustrates an overall flowchart of a collaborative operation method for multiple mowing robots according to Embodiment 1 of the present disclosure;

FIG. 3 schematically illustrates complete map information of workplaces; and

FIG. 4 schematically illustrates a flowchart for determining whether a present mowing robot can complete a corresponding task.

FIG. 5 schematically illustrates a framework diagram for a collaborative operation method for multiple mowing robots according to Embodiment 1 of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a collaborative operation method for multiple mowing robots, a device and a product. The present disclosure can improve mowing efficiency and energy utilization efficiency of the robots.

In order to make the above objective, features and advantages of the present disclosure clearer and more comprehensible, the present disclosure will be further described in detail below in combination with accompanying drawings and particular implementation modes.

### Embodiment 1

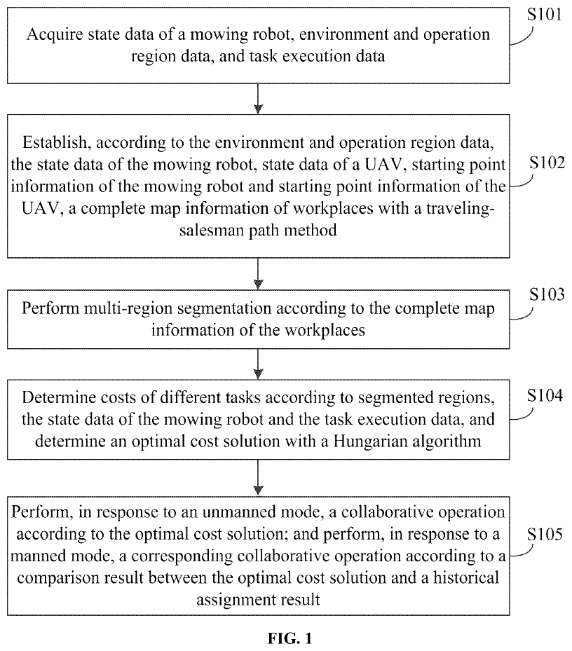

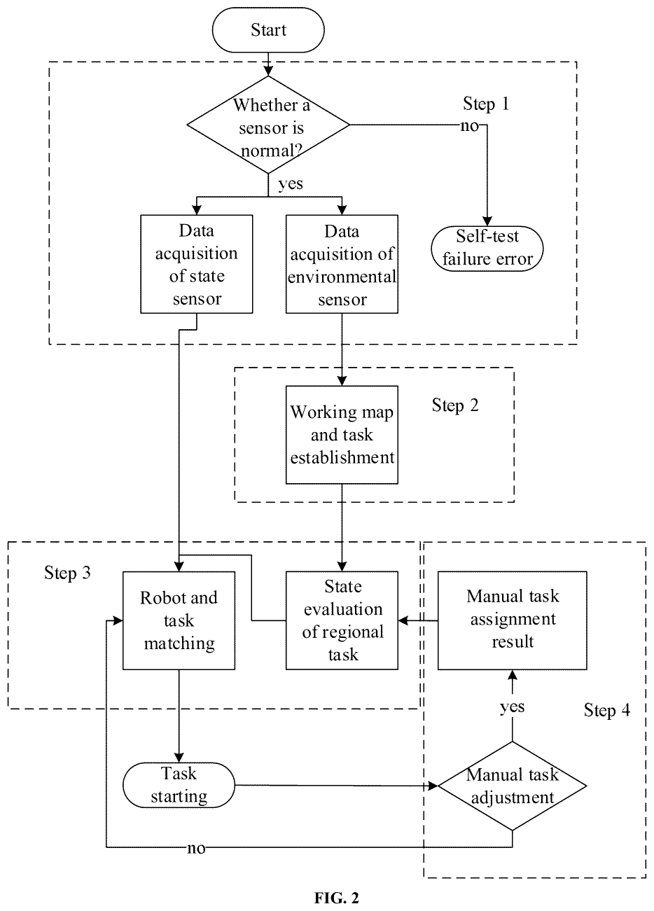

As shown in FIG. 1 and FIG. 2, the present disclosure provides a collaborative operation method for multiple mowing robots, including:

In S101: State data of a mowing robot, environment and operation region data, and task execution data are acquired. The state data includes: an electric capacity or an oil capacity, a blade wearing state, a usage duration, a present position and a present speed. The environment and operation region data includes: positions and boundaries of workplaces, a type, a density and a growing state of a lawn, terrain information, and a weather condition. The task execution data includes: task completion time, an energy consumption record and a mowing quality feedback.

The electric capacity or the oil capacity of the mowing robot is acquired through an electricity sensor or an oil sensor, so as to ensure that the robot can complete an assigned task, and to optimize energy use. The blade wearing state is determined through a duration sensor, so as to predict and plan maintenance, and keep mowing efficiency. For fear of excessive use, a workload of the robot is monitored through the usage duration. A global positioning system (GPS) sensor is used to determine the present position and the present speed of the mowing robot, thereby planning a path according to the present position and the present speed and preventing a conflict between the robots.

The positions and the boundaries of the workplaces are determined through a satellite positioning sensor and a low-accuracy map. Through a visual sensor, the type, the density and the growing state of the lawn are determined, and a mowing strategy is customized to meet different mowing requirements. Through an inertial measurement unit (IMU) sensor, the terrain information (such as a slope, and a position of an obstacle) is acquired, thereby planning an optimal path for the robot and preventing a potential obstacle. Through an Internet of things (IoT) sensor, the weather condition is acquired. According to the weather condition, a task arrangement is adjusted to prevent influences of a severe weather on operation efficiency and safety of the robot.

Through the task completion time, the operation efficiency is evaluated, and the task assignment strategy is optimized. According to the energy consumption record, the energy utilization efficiency is analyzed, and the energy management strategy is optimized. According to the mowing quality feedback (such as uniformity), the mowing strategy is evaluated and optimized.

Collaborative data between the mowing robots is used to optimize a communication strategy between the robots, ensure collaborative operation efficiency and analyze operation effects in different collaborative modes, thereby finding an optimal collaborative strategy.

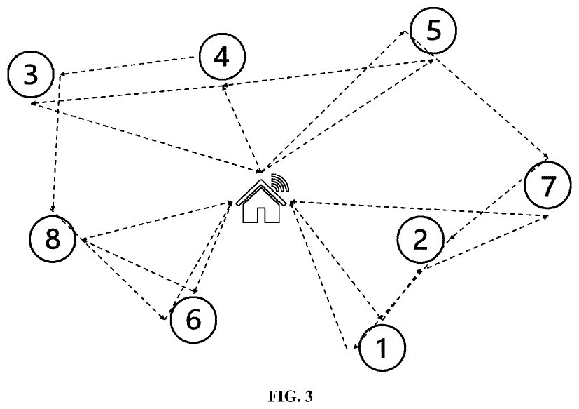

In S102: According to the environment and operation region data, the state data of the mowing robot, state data of a UAV, starting point information of the mowing robot and state information of the UAV, complete map information of the workplaces is established with a traveling-salesman path method. The complete map information of the workplaces includes: information of an obstacle. The complete map information of the workplaces is used to determine an assignment result for the UAV and the mowing robot. As shown in FIG. 3, a center of the map serves as a task starting point for the UAV and the mowing robot, numerical signs represent the positions and the boundaries of the acquired workplaces, a blue path represents a path through which the mowing robot accesses the workplaces, and an orange path represents a path through which the UAV accesses the workplaces.

S102 specifically includes:

A minimum optimization problem is established by min αΣ_{i∈C} (tᵢ-Tᵢ)⁺+z. In the foregoing equation, α represents a penalty coefficient when latest arrival time is missed, tᵢ represents time when the UAV or the mowing robot reaches a node i, Tᵢ represents a latest deadline for completing a task of the node i, z represents a total duration for completing a whole task, and C represents a set of the workplaces.

A constraint is as follows:

$$\begin{matrix}{\sum }_{k ∈ K} {\sum }_{i ∈ C} {y}_{0 , i}^{k} = \vert K \vert \\ {\sum }_{i ∈ N , i \neq j} {y}_{i , j}^{k} = {\sum }_{s ∈ N , s \neq j} {y}_{j , s}^{k} ∀ j ∈ N , ∀ k ∈ K \\ {\sum }_{u ∈ u} {\sum }_{i ∈ N , j \neq i} {y}_{i , j}^{u} \leq 1 ∀ j ∈ C \\ {\sum }_{u ∈ U} {\sum }_{j ∈ N , i \neq j} {y}_{i , j}^{u} \leq 1 ∀ i ∈ C \\ {x}_{i}^{u} + {x}_{j}^{u} - {y}_{i , j}^{u} = 0 , ∀ i , j ∈ C , j \neq i \\ z \geq {t}_{i} ∀ i ∈ C \\ {\sum }_{k ∈ K} {x}_{i}^{k} + {\sum }_{u ∈ U} {x}_{i}^{u} = 1 , ∀ i ∈ C \\ {\sum }_{k ∈ K} {y}_{i , j}^{k} + {\sum }_{u ∈ U} {y}_{i , j}^{u} \leq 1 , ∀ i , j ∈ C , j \neq i \\ {l}_{i} + {d}_{i , j} - ( 1 - {\sum }_{k ∈ K {y}_{i , j}^{k}} ) M \leq {t}_{j} , ∀ i ∈ N , ∀ j ∈ C , j \neq i \\ {t}_{i} + {\hat{d}}_{i , j} - ( 2 - {\sum }_{u ∈ U} {y}_{i , j}^{u} - {\sum }_{u ∈ U} {x}_{j}^{u} ) M \leq {t}_{j} ∀ i , j ∈ C , j \neq i \\ {t}_{i} + {t}_{serνe}^{i} \leq {l}_{i} ∀ i ∈ C \\ {t}_{i} + {\hat{d}}_{j , i} - ( 2 - {\sum }_{u ∈ U} {y}_{j , i}^{u} - {\sum }_{u ∈ U} {x}_{j}^{u} ) M \leq {l}_{j} ∀ i , j ∈ C , j \neq i \\ {\sum }_{k ∈ K} {x}_{i}^{k} * M \geq {q}_{i} ∀ i ∈ C \\ {q}_{i} + {\sum }_{u ∈ U} {\sum }_{s ∈ C , s \neq i} ( {y}_{s , i}^{u} - {y}_{i , s}^{u} ) - ( 1 - {\sum }_{k ∈ K} {y}_{i , i}^{k} ) M \leq {q}_{j} ∀ i ∈ C , ∀ j ∈ C , j \neq i \\ {q}_{i} + {\sum }_{u ∈ U} {\sum }_{s ∈ C , s \neq i} ( {y}_{s , i}^{u} - {y}_{i , s}^{u} ) + ( 1 - {\sum }_{k ∈ K} {y}_{i , i}^{k} ) M \geq {q}_{j} ∀ i ∈ C , ∀ j ∈ C , j \neq i \\ {\sum }_{s ∈ C , s \neq i} ( {\hat{d}}_{s , i} * {y}_{s , i}^{u} ) + {\sum }_{j ∈ C , j \neq i} ( {\hat{d}}_{i , j} * {y}_{i , j}^{u} ) \leq L ∀ i ∈ C , ∀ u ∈ U\end{matrix}$$

In the foregoing equation,

$${y}_{0 , i}^{k}$$

represents a Boolean value, which indicates whether a mowing robot k accesses the node i from a node 0, N and K each represent a set of mowing robots,

$${y}_{i , j}^{k}$$

represents a Boolean value, which indicates whether the mowing robot k accesses a node j from the node i,

$${y}_{j , s}^{k}$$

represents a Boolean value, which indicates whether the mowing robot k accesses a node s from the node j, U represents a set of UAVs,

$${y}_{i , j}^{u}$$

represents a Boolean value, which indicates whether a UAV u accesses the node j from the node i,

$${x}_{i}^{u}$$

represents a Boolean value, which indicates whether the node i is accessed by the UAV u,

$${x}_{j}^{u}$$

represents a Boolean value, which indicates whether the node j is accessed by the UAV u,

$${x}_{i}^{k}$$

represents a Boolean value, which indicates whether the node i is accessed by the mowing robot k, lᵢ represents time when the UAV or the mowing robot leaves away the node i, d_{i,j} represents movement time of the mowing robot from the node i to the node j, M represents a randomly selected positive constant, \hat{d}_{i,j} represents movement time of the UAV from the node i to the node j,

$${t}_{serve}^{i}$$

represents time required to complete the task of the node i,

$${y}_{j , i}^{u}$$

presents a Boolean value, winch indicates whether the UAV u accesses the node i from the node j, qᵢ represents a number of UAVs reaching the node i,

$${y}_{s , i}^{u}$$

represents a Boolean value, which indicates whether the UAV u accesses the node i from the node s,

$${y}_{i , s}^{u}$$

represents a Boolean value, which indicates whether the UAV u accesses the node s from the node i,

$${y}_{i , i}^{k}$$

represents a Boolean value, which indicates whether the mowing robot k accesses the node i from the node i, qⱼ represents a number of UAVs reaching the node j, L represents a maximum flying distance of the UAV, and C represents a number of the workplaces.

In S103: Multi-region segmentation is performed according to the complete map information of the workplaces. Required time, energy consumption, and a machine wearing state are estimated. Task execution data upon execution is estimated.

In S104: Costs of different tasks are determined according to segmented regions, the state data of the mowing robot and the task execution data, and an optimal cost solution is determined with a Hungarian algorithm.

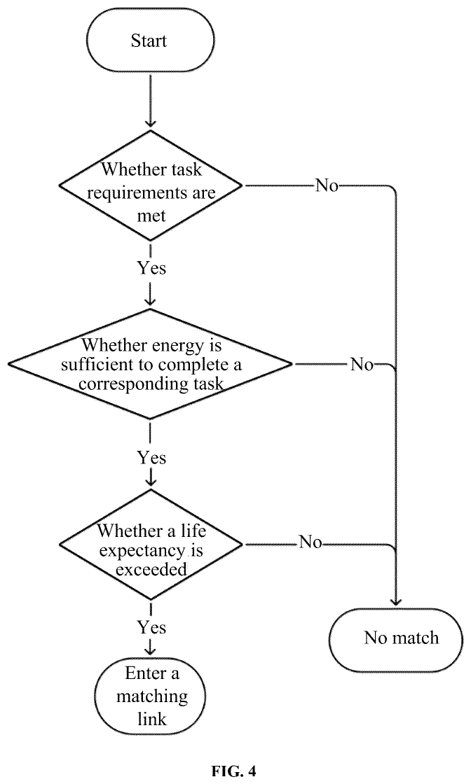

As shown in FIG. 4, before S104, the collaborative operation method for multiple mowing robots further includes:

According to the state data of the mowing robot and the task execution data, whether a present mowing robot can complete a corresponding task is determined.

The costs each are calculated by

$$cost ( {x}_{k} , {m}_{k} ) = \{ \begin{matrix}∞ & no \cdot match \\ ϑ * energy + β * depreciation + γ * \frac{depreciation}{lifeexpectancy} & potential \cdot match\end{matrix} .$$

In the foregoing equation, xₖ represents a mowing robot k, mₖ represents a matched task of the mowing robot k, ∂, β and γ each are a weight coefficient, no match is an indication of no match, depreciation represents a depreciation cost of the mowing robot, and lifeexpectancy represents a designed service life.

In S105: In response to an unmanned mode, a collaborative operation is performed according to the optimal cost solution. In response to a manned mode, corresponding collaborative operation is performed according to a comparison result between the optimal cost solution and a historical assignment result, that is, modification is performed on a task mode correspondingly, thereby improving efficiency.

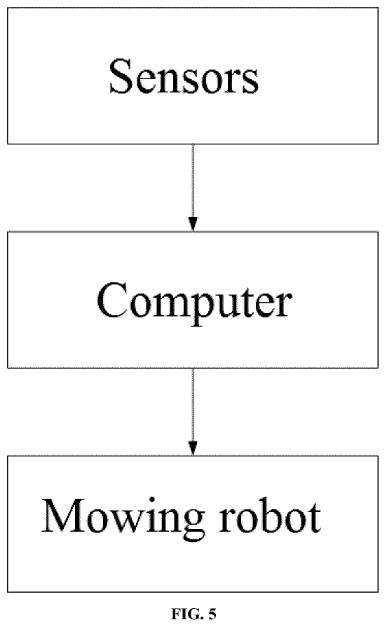

Referring to FIG. 5, the present disclosure provides a collaborative operation method for multiple mowing robots, and a system based on the method.

This method includes the following steps:
acquiring, by sensors, state data of a mowing robot, environment and operation region data, and task execution data, and sending the state data of the mowing robot, environment and operation region data, and task execution data to a computer; wherein the state data comprises: an electric capacity or an oil capacity, a blade wearing state, a usage duration, a present position and a present speed; the environment and operation region data comprises: positions and boundaries of workplaces, a type, a density and a growing state of a lawn, terrain information, and a weather condition; and the task execution data comprises: task completion time, an energy consumption record and a mowing quality feedback;
establishing, by the computer, according to the environment and operation region data, the state data of the mowing robot, state data of an unmanned aerial vehicle (UAV), starting point information of the mowing robot, and starting point information of the UAV, a complete map information of the workplaces with a traveling-salesman path method, wherein the complete map information of the workplaces comprises: information of an obstacle; and the complete map information of the workplaces is used to determine an assignment result for the UAV and the mowing robot;
performing, by the computer, multi-region segmentation according to the complete map information of the workplaces;
determining, by the computer, costs of different tasks according to segmented regions, the state data of the mowing robot and the task execution data, and determining, by the computer, an optimal cost solution with a Hungarian algorithm;
sending, by the computer, the optimal cost solution to the mowing robot; and
performing, by the mowing robot, in response to an unmanned mode, a collaborative operation according to the optimal cost solution; and performing, by the mowing robot, in response to a manned mode, a corresponding collaborative operation according to a comparison result between the optimal cost solution and a historical assignment result.

### Embodiment 2

The present disclosure provides a computer device, including: a memory, a processor and a computer program stored in the memory and executable on the processor. The processor executes the computer program to implement the collaborative operation method for multiple mowing robots in Embodiment 1.

The memory is a computer-readable storage medium.

### Embodiment 3

The present disclosure provides a computer program product, including a computer program. The computer program is executed by a processor to implement the collaborative operation method for multiple mowing robots in Embodiment 1.

### Embodiment 4

The present disclosure provides a computer device. The computer device may be a database. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a nonvolatile storage medium and an internal memory. The nonvolatile storage medium stores an operating system, a computer program and a database. The internal memory provides an environment for operation of the operating system and the computer program in the nonvolatile storage medium. The database of the computer device is configured to store an event to be processed. The I/O interface of the computer device is configured to exchange information between the processor and an external device. The communication interface of the computer device is configured to communicate with an external terminal through a network. The computer program is executed by the processor to implement the collaborative operation method for multiple mowing robots in Embodiment 1.

It is to be noted that information of an object (including but not limited to device information of the object, personal information of the object and the like) and data (including but not limited to data for analysis, data for storage, data for exhibition and the like) in the present disclosure are information and data authorized by the object or fully authorized by each party, and relevant data shall be acquired, used and processed according to laws, regulations and standards of related countries and regions.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to the memory, the database, or other media used in the embodiments of the present disclosure may include at least one of a nonvolatile memory and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external high-speed cache memory. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A collaborative operation method for multiple mowing robots, comprising:
acquiring, by sensors, state data of a mowing robot, environment and operation region data, and task execution data, and sending the state data of the mowing robot, environment and operation region data, and task execution data to a computer; wherein the state data comprises: an electric capacity or an oil capacity, a blade wearing state, a usage duration, a present position and a present speed; the environment and operation region data comprises: positions and boundaries of workplaces, a type, a density and a growing state of a lawn, terrain information, and a weather condition; and the task execution data comprises: task completion time, an energy consumption record and a mowing quality feedback;
establishing, by the computer, according to the environment and operation region data, the state data of the mowing robot, state data of an unmanned aerial vehicle (UAV), starting point information of the mowing robot, and starting point information of the UAV, a complete map information of the workplaces with a traveling-salesman path method, wherein the complete map information of the workplaces comprises: information of an obstacle; and the complete map information of the workplaces is used to determine an assignment result for the UAV and the mowing robot;
performing, by the computer, multi-region segmentation according to the complete map information of the workplaces;
determining, by the computer, costs of different tasks according to segmented regions, the state data of the mowing robot and the task execution data, and determining, by the computer, an optimal cost solution with a Hungarian algorithm;
sending, by the computer, the optimal cost solution to the mowing robot; and
performing, by the mowing robot, in response to an unmanned mode, a collaborative operation according to the optimal cost solution; and performing, by the mowing robot, in response to a manned mode, a corresponding collaborative operation according to a comparison result between the optimal cost solution and a historical assignment result.

2. The collaborative operation method for multiple mowing robots according to claim 1, wherein the establishing, according to the environment and operation region data, the state data of the mowing robot, state data of a UAV, starting point information of the mowing robot, and starting point information of the UAV, a complete map information of the workplaces with a traveling-salesman path method specifically comprises:
establishing a minimum optimization problem by min αΣ_{i∈C} (tᵢ-Tᵢ)⁺+z, wherein, α represents a penalty coefficient when latest arrival time is missed, tᵢ represents time when the UAV or the mowing robot reaches a node i, Tᵢ represents a latest deadline for completing a task of the node i, z represents a total duration for completing a whole task, and C represents a set of the workplaces; and
a constraint is as follows:
$$\begin{matrix}{\sum }_{k ∈ K} {\sum }_{i ∈ C} {y}_{0 , i}^{k} = \vert K \vert \\ {\sum }_{i ∈ N , i \neq j} {y}_{i , j}^{k} = {\sum }_{s ∈ N , s \neq j} {y}_{j , s}^{k} ∀ j ∈ N , ∀ k ∈ K \\ {\sum }_{u ∈ u} {\sum }_{i ∈ N , j \neq i} {y}_{i j}^{u} \leq 1 ∀ j ∈ C \\ {\sum }_{u ∈ U} {\sum }_{j ∈ N , i \neq j} {y}_{i j}^{u} \leq 1 ∀ i ∈ C \\ {x}_{i}^{u} + {x}_{j}^{u} - {y}_{i , j}^{u} = 0 , ∀ i , j ∈ C , j \neq i \\ z \geq {t}_{i} ∀ i ∈ C \\ {\sum }_{k ∈ K} {x}_{i}^{k} + {\sum }_{u ∈ U} {x}_{i}^{u} = 1 , ∀ i ∈ C \\ {\sum }_{k ∈ K} {y}_{i , j}^{k} + {\sum }_{u ∈ U} {y}_{i , j}^{u} \leq 1 , ∀ i , j ∈ C , j \neq i \\ {l}_{i} + {d}_{i , j} - ( 1 - {\sum }_{k ∈ K {y}_{i , j}^{k}} ) M \leq {t}_{j} , ∀ i ∈ N , ∀ j ∈ C , j \neq i \\ {t}_{i} + {\hat{d}}_{i , j} - ( 2 - {\sum }_{u ∈ U} {y}_{i , j}^{u} - {\sum }_{u ∈ U} {x}_{j}^{u} ) M \leq {l}_{j} ∀ i , j ∈ C , j \neq i \\ {t}_{i} + {t}_{serνe}^{i} \leq {l}_{i} ∀ i ∈ C \\ {t}_{i} + {\hat{d}}_{i , j} - ( 2 - {\sum }_{u ∈ U} {y}_{j , i}^{u} - {\sum }_{u ∈ U} {x}_{j}^{u} ) M \leq {l}_{j} ∀ i , j ∈ C , j \neq i \\ {\sum }_{k ∈ K} {x}_{i}^{k} * M \geq {q}_{i} ∀ i ∈ C \\ {q}_{i} + {\sum }_{u ∈ U} {\sum }_{s ∈ C , s \neq i} ( {y}_{s , i}^{u} - {y}_{i , s}^{u} ) - ( 1 - {\sum }_{k ∈ K} {y}_{i , i}^{k} ) M \leq {q}_{j} ∀ i ∈ C , ∀ j ∈ C , j \neq i \\ {q}_{i} + {\sum }_{u ∈ U} {\sum }_{s ∈ C , s \neq i} ( {y}_{s , i}^{u} - {y}_{i , s}^{u} ) + ( 1 - {\sum }_{k ∈ K} {y}_{i , i}^{k} ) M \geq {q}_{j} ∀ i ∈ C , ∀ j ∈ C , j \neq i \\ {\sum }_{s ∈ C , s \neq i} ( {\hat{d}}_{s , i} * {y}_{s , i}^{u} ) + {\sum }_{j ∈ C , j \neq i} ( {\hat{d}}_{i , j} * {y}_{i , j}^{u} ) \leq L ∀ i ∈ C , ∀ u ∈ U\end{matrix}$$
wherein,
$${y}_{0 , i}^{k}$$
represents a Boolean value, which indicates whether a mowing robot k accesses the node i from a node 0, N and K each represent a set of mowing robots,
$${y}_{i , j}^{k}$$
represents a Boolean value, which indicates whether the mowing robot k accesses a node j from the node i,
$${y}_{j , s}^{k}$$
represents a Boolean value, which indicates whether the mowing robot k accesses a node s from the node j, U represents a set of UAVs,
$${y}_{i , j}^{u}$$
represents a Boolean value, winch indicates whether a UAV u accesses the node j from the node i,
$${x}_{i}^{u}$$
represents a Boolean value, which indicates whether the node i is accessed by the UAV u,
$${x}_{j}^{u}$$
represents a Boolean value, which indicates whether the node j is accessed by the UAV u,
$${x}_{i}^{k}$$
represents a Boolean value, which indicates whether the node i is accessed by the mowing robot k, lᵢ represents time when the UAV or the mowing robot leaves away the node i, d_{i,j} represents movement time of the mowing robot from the node i to the node j, M represents a randomly selected positive constant, \hat{d}_{i,j} represents movement time of the UAV from the node i to the node j,
$${t}_{serve}^{i}$$
represents time required to complete the task of the node i,
$${y}_{j , i}^{u}$$
represents a Boolean value, which indicates whether the UAV u accesses the node i from the node j, qᵢ represents a number of UAVs reaching the node i,
$${y}_{s , i}^{u}$$
represents a Boolean value, which indicates whether the UAV u accesses the node i from the node s,
$${y}_{i , s}^{u}$$
represents a Boolean value, which indicates whether the UAV u accesses the node s from the node i,
$${y}_{i , i}^{k}$$
represents a Boolean value, which indicates whether the mowing robot k accesses the node i from the node i, qⱼ represents a number of UAVs reaching the node j, L represents a maximum flying distance of the UAV, and C represents a number of the workplaces.

3. The collaborative operation method for multiple mowing robots according to claim 1, before the determining costs of different tasks according to segmented regions, the state data of the mowing robot and the task execution data, and determining an optimal cost solution with a Hungarian algorithm, further comprising:
determining, according to the state data of the mowing robot and the task execution data, whether a present mowing robot is capable of completing a corresponding task.

4. The collaborative operation method for multiple mowing robots according to claim 1, wherein the costs each are calculated by
$$cost ( {x}_{k} , {m}_{k} ) = \{ \begin{matrix}∞ & no \cdot match \\ ϑ * energy + β * depression + γ * \frac{depreciation}{lifeexpectancy} & potential \cdot match\end{matrix}$$
wherein, xₖ represents a mowing robot k, mₖ represents a matched task of the mowing robot k, ∂, β and γ each are a weight coefficient, no match is an indication of no match, potential match is an indication of a potential match, energy represents the energy consumption record, depreciation represents a depreciation cost of the mowing robot, and lifeexpectancy represents a designed service life.

5. A computer device, comprising: a memory, a processor and a computer program stored in the memory and executable on the processor, wherein the processor executes the computer program to implement the collaborative operation method for multiple mowing robots according to claim 1.

6. The computer device according to claim 5, wherein the memory is a computer-readable storage medium.

7. The computer device according to claim 5, wherein the establishing, according to the environment and operation region data, the state data of the mowing robot, state data of a UAV, starting point information of the mowing robot, and starting point information of the UAV, a complete map information of the workplaces with a traveling-salesman path method specifically comprises:
establishing a minimum optimization problem by min αΣ_{i∈C} (tᵢ-Tᵢ)⁺+z, wherein, α represents a penalty coefficient when latest arrival time is missed, tᵢ represents time when the UAV or the mowing robot reaches a node i, Tᵢ represents a latest deadline for completing a task of the node i, z represents a total duration for completing a whole task, and C represents a set of the workplaces; and
a constraint is as follows:
$$\begin{matrix}{\sum }_{k ∈ K} {\sum }_{i ∈ C} {y}_{0 , i}^{k} = \vert K \vert \\ {\sum }_{i ∈ N , i \neq j} {y}_{i , j}^{k} = {\sum }_{s ∈ N , s \neq j} {y}_{j , s}^{k} ∀ j ∈ N , ∀ k ∈ K \\ {\sum }_{u ∈ u} {\sum }_{i ∈ N , j \neq i} {y}_{i , j}^{u} \leq 1 ∀ j ∈ C \\ {\sum }_{u ∈ U} {\sum }_{j ∈ N , i \neq j} {y}_{i , j}^{u} \leq 1 ∀ i ∈ C \\ {x}_{i}^{u} + {x}_{j}^{u} - {y}_{i , j}^{u} = 0 , ∀ i , j ∈ C , j \neq i \\ z \geq {t}_{i} ∀ i ∈ C \\ {\sum }_{k ∈ K} {x}_{i}^{k} + {\sum }_{u ∈ U} {x}_{i}^{u} = 1 , ∀ i ∈ C {\sum }_{k ∈ K} {y}_{i , j}^{k} + {\sum }_{u ∈ U} {y}_{i , j}^{u} \leq 1 , ∀ i , j ∈ C , j \neq i \\ {l}_{i} + {d}_{i , j} - ( 1 - {\sum }_{k ∈ K {y}_{i , j}^{k}} ) M \leq {t}_{j} , ∀ i ∈ N , ∀ j ∈ C , j \neq i \\ {t}_{i} + {\hat{d}}_{i , j} - ( 2 - {\sum }_{u ∈ U} {y}_{i , j}^{u} - {\sum }_{u ∈ U} {x}_{j}^{u} ) M \leq {t}_{j} ∀ i , j ∈ C , j \neq i \\ {t}_{i} + {t}_{serνe}^{i} \leq {l}_{i} ∀ i ∈ C \\ {t}_{i} + {\hat{d}}_{j , i} - ( 2 - {\sum }_{u ∈ U} {y}_{j , i}^{u} - {\sum }_{u ∈ U} {x}_{j}^{u} ) M \leq {l}_{j} ∀ i , j ∈ C , j \neq i \\ {\sum }_{k ∈ K} {x}_{i}^{k} * M \geq {q}_{i} ∀ i ∈ C \\ {q}_{i} + {\sum }_{u ∈ U} {\sum }_{s ∈ C , s \neq i} ( {y}_{s i}^{u} - {y}_{i p}^{u} ) - ( 1 - {\sum }_{k ∈ K} {y}_{i , i}^{k} ) M \leq {q}_{j} ∀ i ∈ C , ∀ j ∈ C , j \neq i {q}_{i} + {\sum }_{u ∈ U} {\sum }_{s ∈ C , s \neq i} ( {y}_{s i}^{u} - {y}_{i p}^{u} ) + ( 1 - {\sum }_{k ∈ K} {y}_{i , i}^{k} ) M \geq {q}_{j} ∀ i ∈ C , ∀ j ∈ C , j \neq i \\ {\sum }_{s ∈ {C}_{δ , s} \neq i} ( {\hat{d}}_{s , i} * {y}_{s , i}^{u} ) + {\sum }_{j ∈ C , j \neq i} ( {\hat{d}}_{i , j} * {y}_{i , j}^{u} ) \leq L ∀ i ∈ C , ∀ u ∈ U\end{matrix}$$
wherein,
$${y}_{0 , i}^{k}$$
represents a Boolean value, which indicates whether a mowing robot k accesses the node i from a node 0, N and K each represent a set of mowing robots,
$${y}_{i , j}^{k}$$
represents a Boolean value, which indicates whether the mowing robot k accesses a node j from the node i,
$${y}_{j , s}^{k}$$
represents a Boolean value, which indicates whether the mowing robot k accesses a node s from the node j, U represents a set of UAVs,
$${y}_{i , j}^{u}$$
represents a Boolean value, which indicates whether a UAV u accesses the node j from the node i,
$${x}_{i}^{u}$$
represents a Boolean value, which indicates whether the node i is accessed by the UAV u,
$${x}_{j}^{u}$$
represents a Boolean value, which indicates whether the node j is accessed by the UAV u,
$${x}_{i}^{k}$$
represents a Boolean value, which indicates whether the node i is accessed by the mowing robot k, lᵢ represents time when the UAV or the mowing robot leaves away the node i, d_{i,j} represents movement time of the mowing robot from the node i to the node j, M represents a randomly selected positive constant, \hat{d}_{i,j} represents movement time of the UAV from the node i to the node j,
$${t}_{serve}^{i}$$
represents time required to complete the task of the node i,
$${y}_{j , i}^{u}$$
represents a Boolean value, which indicates whether the UAV u accesses the node i from the node j, qᵢ represents a number of UAVs reaching the node i,
$${y}_{s , i}^{u}$$
represents a Boolean value, which indicates whether the UAV u accesses the node i from the node s,
$${y}_{i , s}^{u}$$
represents a Boolean value, which indicates whether the UAV u accesses the node s from the node i,
$${y}_{i , i}^{k}$$
represents a Boolean value, which indicates whether the mowing robot k accesses the node i from the node i, qⱼ represents a number of UAVs reaching the node j, L represents a maximum flying distance of the UAV, and C represents a number of the workplaces.

8. The computer device according to claim 5, before the determining costs of different tasks according to segmented regions, the state data of the mowing robot and the task execution data, and determining an optimal cost solution with a Hungarian algorithm, further comprising:
determining, according to the state data of the mowing robot and the task execution data, whether a present mowing robot is capable of completing a corresponding task.

9. The computer device according to claim 5, wherein the costs each are calculated by
$$cost ( {x}_{k} , {m}_{k} ) = \{ \begin{matrix}∞ & no \cdot match \\ ϑ * energy + β * depression + γ * \frac{depreciation}{lifeexpectancy} & potential \cdot match\end{matrix}$$
wherein, xₖ represents a mowing robot k, mₖ represents a matched task of the mowing robot k, ∂, β and γ each are a weight coefficient, no match is an indication of no match, potential match is an indication of a potential match, energy represents the energy consumption record, depreciation represents a depreciation cost of the mowing robot, and lifeexpectancy represents a designed service life.

10. The computer device according to claim 7, wherein the memory is a computer-readable storage medium.

11. The computer device according to claim 8, wherein the memory is a computer-readable storage medium.

12. The computer device according to claim 9, wherein the memory is a computer-readable storage medium.
